(19) United States
(12) Patent Application Publication
(10) Pub. No.: US 2022/0185443 A1
(43) Pub. Date: Jun. 16, 2022

(54) Lighter Than Air Vehicle Redundant Pressure Sensor Calibration

(71) Applicant: LOON LLC, Mountain View, CA (US)

(72) Inventors: Ewout van Bekkum, Sunnyvale, CA (US); Jonathan Nutzmann, Redwood City, CA (US)

(73) Assignee: LOON LLC, Mountain View, CA (US)

(21) Appl. No.: 17/121,043

(22) Filed: Dec. 14, 2020

(51) Int. Cl. B64B 1/62; G01L 27/00; G01L 19/00

(52) U.S. Cl. CPC B64B 1/62; G01L 19/00; G01L 27/005

(57) ABSTRACT

The technology relates to techniques for lighter than air vehicle redundant pressure sensor calibration. A lighter than air (LTA) vehicle can include a redundant pressure sensor calibration system, including a high precision pressure sensor onboard the LTA vehicle and two or more additional pressure sensors onboard the LTA vehicle, where the two or more additional pressure sensors are each redundant with the high precision pressure sensor. The two or more additional pressure sensors can be calibrated based on pressure measurements from the high precision pressure sensor and the two or more additional pressure sensors at two or more altitudes, wherein the high precision pressure sensor is calibrated before a flight of the LTA vehicle.

### BACKGROUND OF INVENTION

Fleets of lighter than air (LTA) aerial vehicles are being considered for a variety of purposes, including providing data and network connectivity, data gathering (e.g., image capture, weather and other environmental data, telemetry), and systems testing, among others. LTA vehicles can utilize a balloon envelope, a rigid hull, or a non-rigid hull filled with a gas mixture that is lighter than air to provide lift. The gas that is lighter than air within the envelope displaces the heavier air, thereby providing buoyancy to the LTA vehicle. Some LTA vehicles are propelled in a direction of flight using propellers driven by engines or motors and utilize fins to stabilize the LTA vehicle in flight.

Various systems of LTA vehicles rely on ambient pressure measurements. For example, a flight termination system for an LTA vehicle can trigger a flight termination if the LTA vehicle descends below a predetermined altitude, where the altitude of the LTA vehicle is determined using pressure altitude measurements. Some conventional LTA vehicles use ground-based radar systems to measure the height of an LTA vehicle. Some conventional LTA vehicles also utilize pressure measurements from pressure sensors located on a separate aircraft flying in the vicinity of the LTA vehicle to determine the pressure at the altitude of the LTA vehicle. In some cases, the pressure sensors on the aircraft flying in the vicinity of the LTA vehicle are calibrated using a ground-based radar system that measures the altitude of the aircraft.

LTA vehicles can fly at high altitudes, for example, greater than 32,800 feet (10 km) above mean sea level (MSL), or in the stratosphere. Accurate pressure sensors that reliably operate at high altitudes (e.g., above about 30,000 feet above MSL) are expensive. It is also costly to calibrate all of the pressure sensors used on an LTA vehicle beforehand.

### BRIEF SUMMARY

The present disclosure provides techniques for lighter than air vehicle redundant pressure sensor calibration. A lighter than air (LTA) vehicle can include a redundant pressure sensor calibration system, comprising: a high precision pressure sensor onboard an LTA vehicle; two or more additional pressure sensors onboard the LTA vehicle, wherein the two or more additional pressure sensors are each redundant with the high precision pressure sensor; and a processor that is configured to calibrate the two or more additional pressure sensors based on pressure measurements from the high precision pressure sensor and the two or more additional pressure sensors at two or more altitudes, wherein the high precision pressure sensor is calibrated before a flight of the LTA vehicle. In an example, the processor is located onboard the LTA vehicle. In another example, the processor is located offboard the lighter than air vehicle, and the pressure measurements from the high precision pressure sensor and the two or more additional pressure sensors are transmitted from a first communications unit onboard the lighter than air vehicle to a second communications unit coupled to the processor using telemetry. In another example, one of the high precision and the two or more additional pressure sensors is in an enclosure and another of the high precision and the two or more additional pressure sensors is not enclosed. In another example, the high precision pressure sensor is a micro-electromechanical system based sensor coupled to an analog-to-digital converter. In another example, the high precision pressure sensor is calibrated before the flight of the LTA vehicle to be within the acceptable error bounds for altimeter certification according to an industry or regulatory standard (e.g., as may be set by the United States Federal Aviation Administration (FAA) or other aviation administrations and authorities in other jurisdictions). In another example, the high precision pressure sensor is calibrated before the flight of the LTA vehicle at a pressure of 29.921 inches of mercury to measure an altitude of 0 feet with a tolerance of +/−20 feet. In another example, the lighter than air vehicle above, further includes a flight termination subsystem coupled to the PSC system, wherein a second set of pressure measurements from one or more of the high precision pressure sensor and the two or more additional pressure sensors are used to actuate one or more components of the flight termination subsystem. In another example, the one or more components of the flight termination subsystem actuated by the processor comprise one or more squibs. In another example, the flight termination subsystem is configured to actuate the one or more components based on the LTA vehicle descending below an altitude threshold.

A method of calibrating redundant pressure sensors for a lighter than air (LTA) vehicle can include receiving, by a processor, a first pressure measurement measured at a first altitude using a high precision pressure sensor that is onboard an LTA vehicle; receiving, by the processor, a second and a third pressure measurement measured at the first altitude using a first and a second additional pressure sensor, respectively, wherein the first and the second additional pressure sensors are onboard the LTA vehicle, and the first and second additional pressure sensors are each redundant with the high precision pressure sensor; causing an altitude of the LTA vehicle to change to a second altitude; receiving, by a processor, a fourth pressure measurement measured at the second altitude using the high precision pressure sensor; receiving, by a processor, a fifth and a sixth pressure measurement measured at the second altitude using the first and the second additional pressure sensor, respectively; and calibrating, by the processor, the first and second additional pressure sensors using the first, second, third, fourth, fifth and sixth pressure measurements. In an example, the causing the altitude of the lighter than air (LTA) vehicle to change comprises the LTA vehicle ascending during an initial ascent. In another example, the processor is onboard the lighter than air vehicle, and the receiving, by the processor, the first, second, third, fourth, fifth and sixth pressure measurements comprises the processor receiving local signals from the high precision pressure sensor, the first additional pressure sensor, and the second additional pressure sensor. In another example, the processor is located offboard the lighter than air (LTA) vehicle, and the receiving, by the processor, the first, second, third, fourth, fifth and sixth pressure measurements further comprises transmitting signals from a first communications unit onboard the LTA vehicle to a second communications unit coupled to the processor using telemetry. In another example, calibrating, by the processor, the first and second additional pressure sensors using the first, second, third, fourth, fifth and sixth pressure measurements further comprises applying offsets to the second, third, fifth and sixth pressure measurements such that after applying the offsets the second and third pressure measurements from the first additional pressure sensor match the first pressure measurement from the high precision pressure sensor and the fifth and the sixth pressure measurements from the second additional pressure sensor match the fourth pressure measurement from the high precision pressure sensor. In another example, calibrating, by the processor, the first and second additional pressure sensors using the first, second, third, fourth, fifth and sixth pressure measurements comprises interpolating between the pressure measurements measured at the first and second altitudes. In another example, calibrating, by the processor, the first and second additional pressure sensors using the first, second, third, fourth, fifth and sixth pressure measurements further comprises performing statistical analyses of the first, second, third, fourth, fifth and sixth pressure measurements and applying offsets to the measurements from the high precision pressure sensor, the first additional pressure sensor, or the second additional pressure sensor based on the statistical analyses. In another example, the statistical analyses comprise: calculating a mean, a standard deviation, or a coefficient of variation of the first, second and third pressure measurements; and calculating a mean, a standard deviation, or a coefficient of variation of the fourth, fifth and sixth pressure measurements. In another example, calibrating, by the processor, the first and second additional pressure sensors using the first, second, third, fourth, fifth and sixth pressure measurements further comprises the processor voting to determine which measurements from which pressure sensors are used to calibrate the high precision pressure sensor, the first additional pressure sensor, or the second additional pressure sensor. In another example, the above method further includes, after calibrating the first and second additional pressure sensors, receiving pressure measurements from the high precision pressure sensor, and the first and the second additional pressure sensors; comparing the pressure measurements, using the processor, from the high precision pressure sensor, the first additional pressure sensor, and the second additional pressure sensor; calibrating one of the high precision pressure sensor, the first additional pressure sensor, or the second additional pressure sensor based on the pressure measurements of the other two pressure sensors.

### BRIEF DESCRIPTION OF THE DRAWINGS

FIG. 1 is a simplified schematic of an example of a pressure sensor calibration (PSC) system 100 located onboard an LTA vehicle, in accordance with some embodiments.

FIG. 2 is a simplified schematic of an example of a PSC system located partially onboard an LTA vehicle and partially offboard the vehicle, in accordance with some embodiments.

FIGS. 3A and 3B are diagrams of example LTA vehicle systems incorporating PSC systems with redundant pressure sensors, in accordance with some embodiments.

FIG. 4A is a flow diagram illustrating a method for calibrating a pressure sensor onboard an LTA vehicle using a high precision pressure sensor onboard the LTA vehicle, in accordance with some embodiments.

FIG. 4B is a flow diagram illustrating a method for calibrating two pressure sensors onboard an LTA vehicle using a high precision pressure sensor onboard the LTA vehicle, in accordance with some embodiments.

FIG. 5 is a flow diagram illustrating a method for calibrating pressure sensors onboard an LTA vehicle using a high precision pressure sensor onboard the LTA vehicle, in accordance with some embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to redundant pressure sensor calibration for a lighter than air (LTA) vehicle. LTA vehicle pressure sensor calibration (PSC) systems can include a high precision pressure sensor and additional pressure sensors. The high precision pressure sensor can be a pressure transducer that measures absolute pressure and is calibrated before a flight of the LTA vehicle. After calibration (e.g., before a flight) the high precision pressure sensor can then be accurate as well as precise. The additional pressure sensors can be low cost pressure transducers that measure absolute pressure, and one or more of the additional pressure transducers can be redundant with the high precision pressure sensor and/or each other. Redundant pressure sensors are those that can be used to measure the pressure of the same environment (e.g., the ambient air outside of an LTA vehicle). Two redundant pressure sensors that are calibrated the same as one another measure the same pressures as one another when in the same conditions. The additional pressure sensors can be uncalibrated, or can be calibrated with a lower accuracy than the high precision pressure sensor, before a flight of the LTA vehicle. The additional pressure sensors can be less or more precise than the high precision pressure sensor. The PSC system can use measurements from the high precision pressure sensor while the LTA vehicle changes altitude during a flight (e.g., during an initial ascent) to calibrate the additional pressure sensors onboard in situ.

LTA vehicles can use pressure sensors for onboard for navigation, safety, and other purposes. For example, pressure sensors can be used to indicate when the LTA vehicle has reached a target float altitude. Pressure sensors can also be used to safely terminate a flight of an LTA vehicle, for example, if the altitude of the LTA vehicle drops below a predetermined lower limit. In some cases, these systems rely on pressure measurements to be accurate (e.g., pressure altitude measurements with errors less than 20 feet, less than 50 feet, less than 300 feet, less than 1000 feet, or less than 2000 feet). Pressure sensors on an LTA vehicle can be used to measure an altitude of the LTA vehicle from below mean sea level (MSL) to altitudes greater than 45,000 feet, or at altitudes greater than 50,000 feet, or at altitudes greater than 60,000 feet. In some cases, pressure sensors can be used to determine if the LTA vehicle is within regulated airspace, such as Class A Airspace, by correlating a measured pressure to an altitude. Various subsystems of the LTA vehicle can take different actions depending on the altitude of the LTA vehicle, and the present PSC systems can improve the accuracy of the pressure (and thereby altitude) measurements.

Accurate pressure sensors that reliably operate at high altitudes (e.g., above about 30,000 feet above MSL) are expensive. It is also costly to calibrate all of the pressure sensors used on an LTA vehicle beforehand, due to the costs per sensor unit and the costs associated with continuously updating manufacturing workflows as components and designs of the LTA vehicle change. The PSC systems described herein are capable of calibrating two or more low cost pressure sensors in situ using measurements from a single high precision pressure sensor, and therefore provide accurate redundant pressure measurements during the flight of an LTA vehicle with a single costly pressure sensor. In some cases, more than one high precision pressure sensor can also be used to calibrate the additional (e.g., low cost) pressure sensors for added redundancy.

A PSC system for an LTA vehicle can contain an accurate onboard high precision pressure sensor, and additional onboard pressure sensors. For example, the accurate high precision pressure sensor can be calibrated before a flight of the LTA vehicle, while the additional pressure sensors can be uncalibrated and/or the accuracy of the additional pressure sensors can be unknown. The PSC system can use a processor to receive measurements from the plurality of onboard pressure sensors and then calibrate one or more of the pressure sensors based on the measurements from the other pressure sensors. For example, measurements from one pressure sensor (e.g., the accurate high precision pressure sensor) can be used to calibrate the other pressure sensors. In another example, measurements from more than one pressure sensor (e.g., wherein at least one of the more than one pressure sensors are accurate, for example, having been calibrated previously) can be used to calibrate the pressure sensors in the system (e.g., using voting or averaging). In some cases, memory (e.g., non-transitory computer readable memory) is coupled to the processor, and the measurements from the high precision and the additional pressure sensors are stored in the memory. The measurements stored in the memory are accessible by the processor, which can use the measurements to calibrate one or more of the pressure sensors in the PSC. The PSC systems described herein can use any algorithm to calibrate one or more of the pressure sensors in the PSC system based on measurements from the pressure sensors in the PSC system.

For example, the PSC systems described herein can take several sets of measurements from an accurate (e.g., previously calibrated) high precision pressure sensor and two (or more) additional pressure sensors at different altitudes during a flight of an LTA vehicle. Since the ambient air pressure changes with altitude, this procedure will generate sets of measurements (e.g., from 5 to 20, from 10 to 100, greater than 5, greater than 10, greater than 100 measurements, or within other ranges) at different pressures. The measurements can be compared with one another, and one (or more) of the additional pressure sensors can be calibrated to match the measurements of the accurate high precision pressure sensor for each set of measurements (e.g., for each altitude where measurements were taken). For example, differences between the measurements from each of the additional pressure sensors and the accurate high precision pressure sensor can be stored (e.g., in memory coupled to the processor) for each set of measurements taken at different altitudes, and then offsets can be applied, based on the differences, to calibrate each of the additional pressure sensors. In some cases, the additional pressure sensors output a raw (uncalibrated) measurement, and the processor applies a calibration offset based on the stored values generated in the above procedure.

In some cases, a calibration procedure (e.g., any calibration procedure described herein) can include interpolation between data points (e.g., between the measurements taken at each altitude). For example, a function (e.g., a linear function, an nth degree polynomial, a logarithmic function, a power function, or an exponential function) can be fit to the calibrated points (e.g., to the calibrated pressure measurements, or the calibration offsets) to improve the pressure sensing accuracy for pressures in between the sets of pressure measurements used at the different altitudes during the above calibration procedure. In some cases, a lookup table of calibration offsets for any pressures between the measured points can be generated (and stored in memory accessible by a processor) using the measured pressures and interpolating between the measured points. In some cases, the fitted function or lookup table can include pressures beyond the range of the measured points by extrapolating from the measured data.

In some cases, the PSC systems described herein can take several sets of measurements from an accurate (e.g., previously calibrated) high precision pressure sensor and two (or more) additional pressure sensors at different altitudes during a flight of an LTA vehicle, and the measurements from all of the pressure sensors can be used to calibrate one or more of the pressure sensors of the PSC system. For example, all of the measurements from the pressure sensors at a particular altitude can be averaged to determine an average pressure, and the processor can determine the calibration offsets to apply to measurements from one or more of the pressure sensors (e.g., to all of the pressure sensors, or to all of the pressure sensors except the high precision pressure sensor) to match the determined average pressure. The processor can then store the calibration offsets (e.g., in memory coupled to the processor) and apply those offsets to the raw measurements of the pressure sensors in subsequent measurements.

In some cases, the PSC systems described herein can take several sets of measurements from an accurate (e.g., previously calibrated) high precision pressure sensor and two (or more) additional pressure sensors at different altitudes during a flight of an LTA vehicle, and the measurements from two or more of the pressure sensors can be used to calibrate one or more of the pressure sensors of the PSC system. For example, all of the measurements from the pressure sensors at a particular altitude can be compared to determine if any of the pressure sensors is measuring a pressure significantly different from the other pressure sensors. For example, all of the pressure measurements at a particular altitude can be analyzed statistically (e.g., to determine a mean, standard deviation, coefficient of variation, and/or other statistical parameters of the distribution of measurements), and then each pressure sensor can be designated as within a particular error bound, or outside of a particular error bound. The processor can then determine calibration offsets to apply to measurements from one or more of the pressure sensors (e.g., to all of the pressure sensors, to all of the pressure sensors except the high precision pressure sensor) outside of a particular bound, based on the measurements (or a statistical distribution of measurements) from one or more of the pressure sensors within a particular error bound. The processor can then store the calibration offsets (e.g., in memory coupled to the processor) and apply those offsets to the raw measurements of the pressure sensors in subsequent measurements.

In an example, a PSC system contains one accurate (e.g., previously calibrated) high precision pressure sensor and five additional pressure sensors, all of which are onboard an LTA vehicle. The measurements are recorded from the six pressure sensors at 10 different altitudes as the LTA vehicle ascends (and/or descends). The measurements at each altitude are then analyzed statistically to determine the mean pressure and the coefficient of variation of the pressures measured. An error bound in this example is predetermined to be two coefficients of variation away from the mean. If any of the additional pressure sensors in this example produces measurements that are more than two coefficients of variation away from the mean, then it is designated as outside the error bound, and that pressure sensor can be calibrated using calibration procedures described herein (e.g., as determined by the high precision pressure sensor, or from the mean of all of the pressure sensors that are inside the error bound, or from all of the pressure sensors that output raw pressure measurements that are less than two coefficients of variation away from the mean).

In some cases, the PSC systems described herein can take several sets of measurements from an accurate (e.g., previously calibrated) high precision pressure sensor and two (or more) additional pressure sensors at different altitudes during a flight of an LTA vehicle, and the processor can vote to determine which measurements from which of the pressure sensors are used to calibrate one or more of the pressure sensors of the PSC system. The processor can vote to determine which measurements from which of the pressure sensors are used based on statistical distributions of the measurements, comparisons between the measurements from different pressure sensors, or any other criteria. For example, if a PSC system contains three pressure sensors, and two of the pressure sensors are outputting similar measurements (e.g., within a certain absolute percentage difference, such as within 1% or 5% difference), while one of the pressure sensors is outputting a different measurement (e.g., greater than a certain absolute percentage difference, such as greater than a 1% or 5% difference), then the one pressure sensor outputting the different pressure measurement can be calibrated based on the measurement of one or both of the other pressure sensors (e.g., using procedures described herein). In some cases, the processor can vote to determine which measurements from which of the additional pressure sensors are used based on measurements from the high precision pressure sensor.

In some cases of PSC system calibration procedures that use voting, measurements from a plurality of additional pressure sensors can be compared to measurements from an accurate (e.g., previously calibrated) high precision pressure sensor (e.g., at different altitudes) to determine which measurements to use for calibration. For example, any additional pressure sensors that output similar measurements to the accurate high precision pressure sensor (e.g., within a certain absolute percentage difference, such as within 1% or 5% difference) can be used to calibrate any additional pressure sensors outputting a measurements that are different from those of the accurate high precision pressure sensor (e.g., greater than a certain absolute percentage difference, such as greater than a 1% or 5% difference). In such cases, the pressure sensors outputting the different pressure measurement can be calibrated based on the measurements of the accurate high precision pressure sensors and/or the other pressure sensors (e.g., using procedures described herein).

In some cases, the processor is located locally onboard the LTA vehicle. In other cases, the processor is located offboard the LTA vehicle (e.g., in a datacenter located on the ground), and the measurements from the sensors can be sent from a communications unit onboard the LTA vehicle to an offboard communications unit coupled to the processor using telemetry (e.g., collected via WiFi, mmWave, FSOC, or SATCOM backhaul).

A PSC system can be configured to perform a method (e.g., using a processor coupled to non-transitory computer readable memory) including collecting pressure measurements at different altitudes (e.g., as an LTA vehicle ascends and/or descends) using the high precision onboard pressure sensor and additional onboard pressure sensors. The processor can be used to receive the pressure measurements and to calibrate one or more of the pressure sensors using the measurements from one or more of the other pressure sensors (e.g., calibrating the additional sensors using the measurements from the high precision sensor). In some cases, the pressure sensors can be calibrated using measurements collected during an initial ascent of the LTA vehicle, which can include measuring pressures at altitudes between the ground (e.g., approximately sea level, or approximately MSL) and a float altitude (e.g., from 45,000 to 65,000 feet, or up to 75,000 feet). In other cases, the pressure sensors can be calibrated using measurements collected during an ascent and/or descent of the LTA vehicle, which can include measuring pressures at altitudes between the ground (e.g., approximately sea level) and a float altitude (e.g., from 45,000 to 65,000 feet, or up to 75,000 feet). An LTA vehicle may have a range of float altitudes, where a float altitude floor can be approximately 45,000 feet, 50,000 feet, or from 45,000 feet to 55,000 feet, and a float altitude ceiling can be approximately 65,000 feet or approximately 75,000 feet, or from approximately 65,000 feet to approximately 75,000 feet. In some cases, the float altitude can be lower than 45,000 feet, such as from 20,000 feet to 45,000 feet. In some cases, the pressure sensors can be calibrated using measurements collected while the LTA vehicle is ascending and descending.

In some cases, the PSC systems described herein can take a first set of measurements from onboard pressure sensors as an LTA vehicle is ascending, and a second set of measurements from onboard pressure sensors while the LTA vehicle is descending. The first set of measurements can be used to calibrate one or more of the pressure sensors of the PSC system for ascending pressures (i.e., pressures measured while the LTA vehicle is ascending), and the second set of measurements can be used to calibrate one or more of the pressure sensors of the PSC for descending pressures (i.e., pressures measured while the LTA vehicle is descending). This can be advantageous because some types of pressure sensors can suffer from some amount of hysteresis. For example, a pressure sensor measuring a particular ambient pressure can output a different measured pressure when arriving at that particular ambient pressure from higher pressures (e.g., as would be the case during an ascent of an LTA vehicle) than it does when arriving at that particular ambient pressure from lower pressures (e.g., as would be the case during a descent of an LTA vehicle).

The PSC systems and methods described herein can also be used to monitor drift of pressure sensors (e.g., over long duration flights, such as longer than 6 months). In some cases, PSC systems include a high precision pressure sensor and additional pressure sensors, where the additional pressure sensors are redundant, and a processor compares measurements between different pressure sensors over time to detect if one or more pressure sensors has drifted (e.g., using any of the calibration procedures described herein, such as voting and/or using statistical analysis). Such comparisons can be used to monitor for drift in pressure sensing across both the initially uncalibrated and the high precision calibrated pressure sensors. For example, if one pressure sensor has drifted and measures a different pressure than two or more other sensors that agree with one another, then the pressure sensor that has drifted can be recalibrated using the two or more other sensors that are in agreement. Pressure sensors can drift, for example, due to aging (e.g., of an electric mechanical transducer component), an event that damages the sensor, or other reasons. In some cases, a pressure sensor can fail, and be unable to measure accurately (even after calibration), and in such cases, the processor can ignore or turn off the failed pressure sensor. In some cases, measurements from the high precision pressure sensor and/or the additional pressure sensors can be used to determine if a pressure sensor has failed (e.g., by comparing measurements from the different pressure sensors).

In an example, the PSC systems and methods described herein can be used to improve the accuracy of pressure measurements (as well as derived geopotential pressure altitude and/or estimated vertical dynamic pressure) used to initiate safety critical squib triggers at high altitudes (e.g., above about 30,000 feet above MSL). In some cases, such squib triggers can be used to actuate safety critical descent subsystems, for instance as a part of a flight termination system for the LTA vehicle. In some cases, a flight termination system of an LTA vehicle actuates components of the system based on absolute pressure measurements from pressure sensors onboard the LTA vehicle, and also actuates components based on dynamic pressures.

In some cases, the additional pressure sensors can be located in regions of the LTA vehicle that have the same or different conditions (e.g., moisture content and/or temperature) compared to those experienced by the high precision pressure sensor. For example, the high precision pressure sensor can be located in an enclosure (e.g., within a payload of the LTA vehicle) or can be not enclosed, while the additional sensors can be located within enclosures or can be not enclosed. In some cases, one or more additional pressure sensors can be located on-chip (e.g., within an enclosure containing other electronics). In some cases, the high precision pressure sensor may be unavailable for a portion of the time (e.g., because of hardware problems, software problems, connectivity problems, separation of parts of the LTA vehicle after a flight is terminated, damage to the LTA vehicle, or other reasons) and it is beneficial to have redundant pressure sensors on the LTA vehicle. High precision pressure sensors (or otherwise calibrated pressure sensors) are costly, and therefore it can also be advantageous to have redundant additional pressure sensors (e.g., less costly pressure sensors) that are calibrated in situ to provide accurate measurements even if the high precision pressure sensor becomes unavailable.

In some cases, the PSC systems described herein can take several sets of measurements from a high precision pressure sensor, from two (or more) additional pressure sensors, and from one or more temperature sensors at different altitudes during a flight of an LTA vehicle, and the measurements from one or more (or all) of the pressure sensors and from the temperature sensors can be used to calibrate one or more (or all) of the pressure sensors of the PSC system. In such cases, the offsets or other calibration corrections made by the processor can take temperature measurements into account. For example, calibration offsets can be associated with a particular raw pressure output from a pressure sensor and a particular temperature (or temperature range) measured using a temperature sensor. Then, the raw pressure output by the pressure sensor and the temperature measured using a temperature sensor can be used to determine which calibration offsets to apply to a particular pressure sensor (e.g., using a lookup table, or other calibration functions stored in memory accessible by a processor). In some cases, a standard temperature pressure model can be used to determine a temperature from a measured pressure (e.g., taken during an initial ascent of an LTA vehicle), without using a temperature sensor. In other cases, temperature measurements (e.g., taken using a temperature sensor during an initial ascent of an LTA vehicle) can be used in conjunction with pressure measurements, instead of relying on a standard temperature pressure model. In some cases, for example when an LTA vehicle is at a float altitude, multidimensional data (e.g., raw pressure, reference pressure, temperature) can be collected from all of the sensors (e.g., pressure sensors and a temperature sensor) and the multidimensional data can be used by the PSC systems described herein.

In some cases, the PSC system can use a pressure altitude sensor that is a pressure altimeter, which approximates altitude by measuring atmospheric pressure. In some cases, the PSC system can use an absolute pressure sensor that is a pressure sensor without built in signal conditioning or amplification of the output (e.g., with an electrical output in the millivolts range, such as from 0-50 mV), or can be a pressure transducer with signal conditioning and/or amplification of the output (e.g., an electrical output in the volts range, such as from 0-10 V). In some cases, a supply voltage provided to the pressure sensors is from 5 V DC to 10 V DC, or from 8 V DC to 28 V DC.

The accurate high precision pressure sensor used by the PSC systems can be any pressure sensor and/or altimeter with sufficient parameters. For example, the accurate high precision pressure sensor can be a micro-electromechanical system (MEMS) based sensor paired with a precision analog-to-digital converter (e.g., a 24 bit sigma delta ADC) and calibrated on the ground before flight. In some cases, the accurate high precision pressure sensor is calibrated to be within the acceptable error bounds for altimeter certification according to an industry or regulatory standard (e.g., as may be set by the United States Federal Aviation Administration (FAA) or other aviation administrations and authorities in other jurisdictions). For example, the accurate high precision pressure sensor can calibrated at atmospheric pressure at MSL (i.e., 29.921 inches of mercury) to measure an altitude of 0 feet with a tolerance of +/−20 feet. In some cases, the accurate high precision pressure sensor may be calibrated at pressures between approximately 31.018 inches of mercury (corresponding to approximately −1000 feet above MSL) and approximately 3.425 inches of mercury (corresponding to approximately 50,000 feet above MSL), for example, to produce altitude measurements and tolerances ranging from −1000+/−20 feet at approximately 31.018 inches of mercury to 50,000+/−280 feet at approximately 3.425 inches of mercury (e.g., according to altimeter system test and inspection standards, for example, as set forth in 14 CFR Appendix E to Part 43 at Section (b)(1)(i) Table I). In other cases, the accurate high precision pressure sensor may be calibrated using a hysteresis test (e.g., 14 CFR Appendix E to Part 43 at Section (b)(1)(ii) and Table II). In some cases, the accurate high precision pressure sensor may be calibrated using a pressure-altitude difference test (e.g., 14 CFR Appendix E to Part 43 at Section (b)(1)(vi) and Table IV).

The additional pressure sensors used by the PSC system can be any pressure sensors, for example, with a digital interface (e.g., inter-integrated circuit (I2C) or serial peripheral interface (SPI)). The additional pressure sensors may be previously calibrated, but may have a lower accuracy and/or precision than the high precision pressure sensor used by the PSC system. In some cases, the additional pressure sensors can be board mounted pressure sensors (e.g., TE MS560702BA03-50, Amphenol NPA-700B-015A, and Honeywell MPRLS0015PA0000SA).

Example Systems

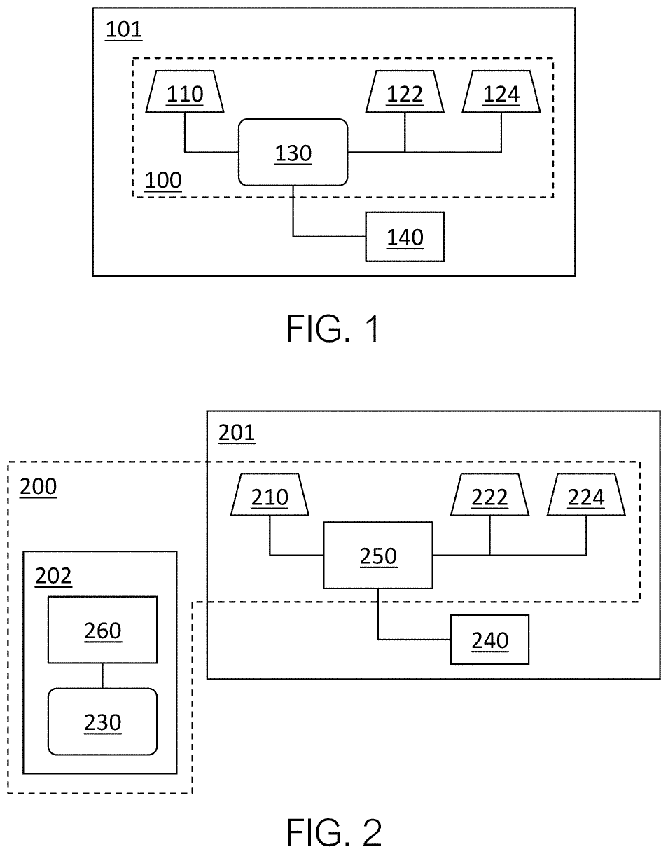

FIG. 1 is a simplified schematic of an example of a pressure sensor calibration (PSC) system 100 located onboard an LTA vehicle 101. The PSC system 100 includes, an accurate high precision pressure sensor 110, two additional pressure sensors 122 and 124, and a processor 130. Additional pressure sensor 122 and/or 124 can be redundant with the high precision pressure sensor 110. Memory (not shown) can also be coupled to the processor 130, in order to store raw sensor data (e.g., measurements) from the sensors 110, 122 and 124. In this example, the pressure sensors 110, 122 and 124 are located onboard the LTA vehicle 101. The processor 130, in this example, is located onboard the LTA vehicle 101. The processor 130 can receive measurements from the accurate high precision pressure sensor 110, and the additional pressure sensors 122 and 124, and can use the received measurements to calibrate one or more of the pressure sensors 110, 122 and 124, as described herein. Processor 130 is also coupled to a subsystem 140 of LTA vehicle 101. For example, subsystem 140 can be a flight termination system (or a portion of a flight termination system) that uses pressure measurements to actuate one or more components of the flight termination subsystem. For example, subsystem 140 can be a flight termination system that can trigger a squib to fire and terminate the flight of an LTA vehicle upon descending below an altitude threshold (where the altitude of the LTA vehicle is determined (or partially determined) using pressure altitude sensors, i.e., using sensors that relate a measured pressure to an altitude). For example, the flight termination system that can actuate components to terminate the flight of an LTA vehicle upon descending below an altitude threshold at or slightly above or below 10,000 feet, 20,000 feet, or 35,000 feet for a stratospheric balloon, or higher or lower for other types of LTA vehicles.

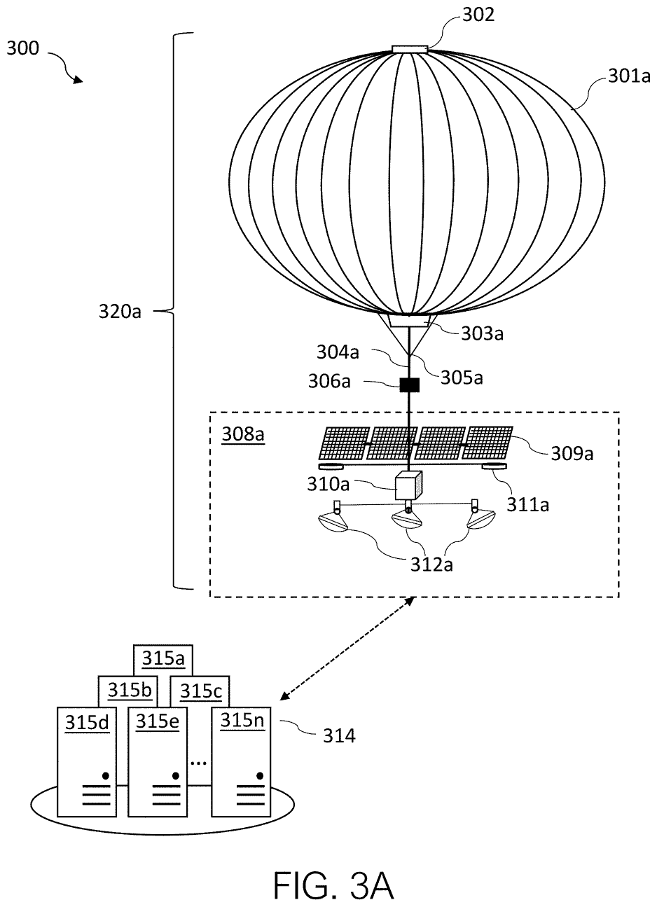

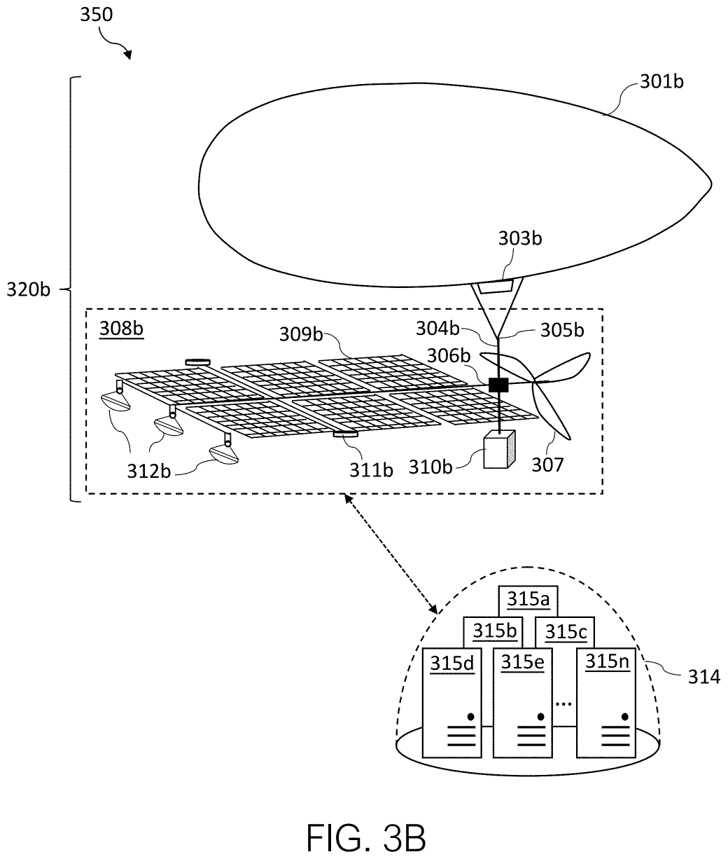

FIG. 2 is a simplified schematic of an example of a PSC system 200 located partially onboard an LTA vehicle 201 and partially located in a location offboard the LTA vehicle (e.g., a data center on the ground) 202. The PSC system 200 includes, an accurate high precision pressure sensor 210, two additional pressure sensors 222 and 224, an onboard communications subsystem 250 (e.g., communications units 311a and 311b in FIGS. 3A-3B), an offboard communications subsystem 260, and a processor 230. Additional pressure sensor 222 and/or 224 can be redundant with the accurate high precision pressure sensor 210. In this example, the pressure sensors 210, 222 and 224, and communications subsystem 250 are located onboard the LTA vehicle 201. The communications subsystem 250 receives measurements from the sensors 210, 222 and 224, and then communicates (or transmits) the measurements to the offboard communications subsystem 260. The offboard communications subsystem 260 can communicate with the communications subsystem 250 onboard the LTA vehicle, for example, using WiFi, mmWave, FSOC, or SATCOM backhaul. Processor 230 can then calibrate the one or more of the pressure sensors 210, 222 and/or 224, based on the received measurements, using procedures described herein. The offboard subsystem 260 can then send instructions from the processor 230 to the communications subsystem 250. The processor 230 can then use the calibrated measurements from the pressure sensors 210, 222 and/or 224, for example, to control a subsystem 240, by communicating through communications subsystems 250 and 260. In some cases, the subsystem 240 can be a flight termination system (or a portion of a flight termination system) that uses pressure measurements to actuate one or more systems.

FIGS. 3A-3B are diagrams of example LTA vehicle systems incorporating PSC systems with redundant pressure sensors, in accordance with some embodiments. The LTA vehicles 320a-b shown in FIGS. 3A-3B, and described further below, contain PSC systems with redundant pressure sensors that can be calibrated using one or more onboard pressure sensors (e.g., a high precision pressure sensor), as described above.

In FIG. 3A, there is shown a diagram of system 300 for navigation of LTA vehicle 320a. In some examples, LTA vehicle 320a may be a passive vehicle, such as a balloon or satellite, wherein most of its directional movement is a result of environmental forces, such as wind and gravity. In other examples, LTA vehicles 320a may be actively propelled. In an embodiment, system 300 may include LTA vehicle 320a and ground station 314. In this embodiment, LTA vehicle 320a may include balloon 301a, plate 302, altitude control system (ACS) 303a, connection 304a, joint 305a, actuation module 306a, and payload 308a. In some examples, plate 302 may provide structural and electrical connections and infrastructure. Plate 302 may be positioned at the apex of balloon 301a and may serve to couple together various parts of balloon 301a. In other examples, plate 302 also may include a flight termination unit (e.g., that is a part of the FTS system), such as one or more blades and an actuator to selectively cut a portion and/or a layer of balloon 301a. ACS 303a may include structural and electrical connections and infrastructure, including components (e.g., fans, valves, actuators, etc.) used to, for example, add and remove air from balloon 301a (i.e., in some examples, balloon 301a may include an interior ballonet within its outer, more rigid shell that is inflated and deflated), causing balloon 301a to ascend or descend, for example, to catch stratospheric winds to move in a desired direction. Balloon 301a may comprise a balloon envelope comprised of lightweight and/or flexible latex or rubber materials (e.g., polyethylene, polyethylene terephthalate, chloroprene), tendons (e.g., attached at one end to plate 302 and at another end to ACS 303a) to provide strength to the balloon structure, a ballonet, along with other structural components. In various embodiments, balloon 301a may be non-rigid, semi-rigid, or rigid.

Connection (i.e., down-connect) 304a may structurally, electrically, and communicatively, connect balloon 301a and/or ACS 303a to various components comprising payload 308a. In some examples, connection 304a may provide two-way communication and electrical connections, and even two-way power connections. Connection 304a may include a joint 305a, configured to allow the portion above joint 305a to pivot about one or more axes (e.g., allowing either balloon 301a or payload 308a to tilt and turn). Actuation module 306a may provide a means to actively turn payload 308a for various purposes, such as improved aerodynamics, facing or tilting solar panel(s) 309a advantageously, directing payload 308a and propulsion units (e.g., propellers 307 in FIG. 3B) for propelled flight, or directing components of payload 308a advantageously.

Payload 308a may include solar panel(s) 309a, avionics chassis 310a, broadband communications unit(s) 311a, and terminal(s) 312a. Solar panel(s) 309a may be configured to capture solar energy to be provided to a battery or other energy storage unit, for example, housed within avionics chassis 310a. Avionics chassis 310a also may house a flight computer (e.g., to electronically control various systems within the LTA vehicle 320a), a transponder, along with other control and communications infrastructure (e.g., a computing device and/or logic circuit configured to control LTA vehicle 320a). In some cases, the flight computer is the processor (e.g., 130 in FIG. 1) that is used to calibrate the onboard pressure sensors, as described herein. Communications unit(s) 311a may include hardware to provide wireless network access (e.g., LTE, fixed wireless broadband via 5G, Internet of Things (IoT) network, free space optical network or other broadband networks). Terminal(s) 312a may comprise one or more parabolic reflectors (e.g., dishes) coupled to an antenna and a gimbal or pivot mechanism (e.g., including an actuator comprising a motor). Terminal(s) 312a may be configured to receive or transmit radio waves to beam data long distances (e.g., using the millimeter wave spectrum or higher frequency radio signals). In some examples, terminal(s) 312a may have very high bandwidth capabilities. Terminal(s) 312a also may be configured to have a large range of pivot motion for precise pointing performance Terminal(s) 312a also may be made of lightweight materials.

The pressure sensors (e.g., 110, 122, 124, 210, 222, and/or 224 in FIGS. 1-2) (not shown) can be part of the payload 308a, or can be coupled to another part of the LTA vehicle 320a such as the actuation module 306a on the down-connect 304a, or to the apex plate 302 on the envelope 301a. For example, the high precision sensor (e.g., 110 in FIG. 1, or 210 in FIG. 2) (not shown) can be co-located with communications unit 311a (e.g., a SATCOM node), where it will have a high availability. In some cases, the additional pressure sensors (not shown) are co-located with the actuation systems (e.g., actuation module 306a, the ACS 303a, or flight termination systems coupled to the apex plate 302) and accordingly can be located many places on the LTA vehicle.

In other examples, payload 308a may include fewer or more components, including propellers 307 as shown in FIG. 3B, which may be configured to propel LTA vehicles 320a-b in a given direction. In still other examples, payload 308a may include still other components well known in the art to be beneficial to flight capabilities of an LTA vehicle. For example, payload 308a also may include energy capturing units apart from solar panel(s) 309a (e.g., rotors or other blades (not shown) configured to be spun by wind to generate energy). In another example, payload 308a may further include or be coupled to an imaging device (e.g., a star tracker, IR, video, Lidar, and other imaging devices, for example, to provide image-related state data of a balloon envelope, airship hull, and other parts of an LTA vehicle). In another example, payload 308a also may include various sensors (not shown) in addition to the high precision and additional pressure sensors described herein, for example, housed within avionics chassis 310a or otherwise coupled to connection 304a or balloon 301a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

Ground station 314 may include one or more server computing devices 315a-n, which in turn may comprise one or more computing devices (e.g., a computing device and/or logic circuit configured to control LTA vehicle 320a). In some examples, ground station 314 also may include one or more storage systems, either housed within server computing devices 315a-n, or separately. Ground station 314 may be a datacenter servicing various nodes of one or more networks. In some cases, the processor (e.g., 230 in FIG. 2) is located in ground station 314, for example in one of computing devices 315a-n.

FIG. 3B shows a diagram of system 350 for navigation of LTA vehicle 320b. All like-numbered elements in FIG. 3B are the same or similar to their corresponding elements in FIG. 3A, as described above (e.g., balloon 301a and balloon 301b may serve the same function, and may operate the same as, or similar to, each other). In some examples, balloon 301b may comprise an airship hull or dirigible balloon. In this embodiment, LTA vehicle 320b further includes, as part of payload 308b, propellers 307, which may be configured to actively propel LTA vehicle 320b in a desired direction, either with or against a wind force to speed up, slow down, or re-direct, LTA vehicle 320b. In this embodiment, balloon 301b also may be shaped differently from balloon 301a, to provide different aerodynamic properties.

As shown in FIGS. 3A-3B, LTA vehicles 320a-b may be largely wind-influenced LTA vehicle, for example, balloons carrying a payload (with or without propulsion capabilities) as shown, or fixed wing high altitude drones (not shown) with gliding and/or full propulsion capabilities. However, those skilled in the art will recognize that the systems disclosed herein may similarly apply and be usable by various other types of LTA vehicles.

Example Methods

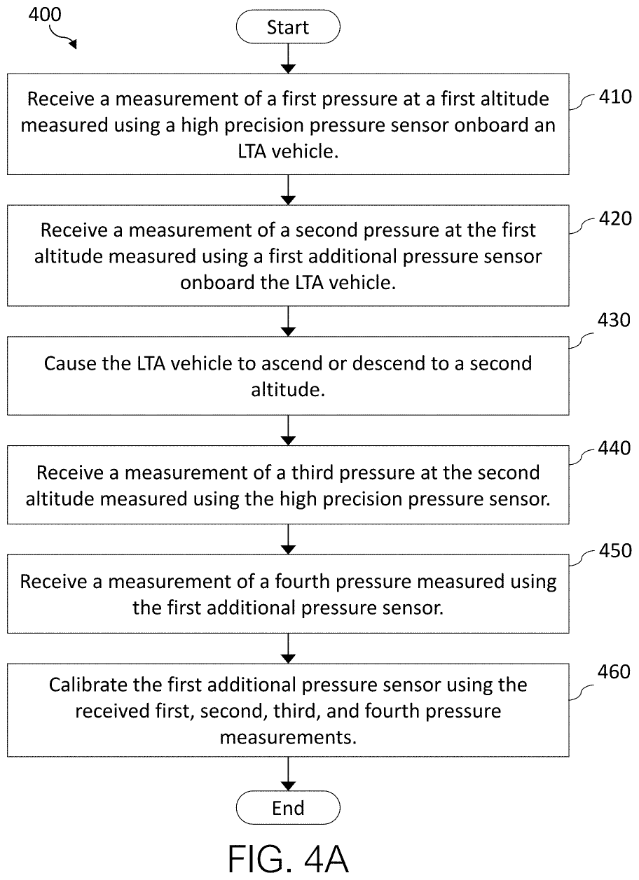

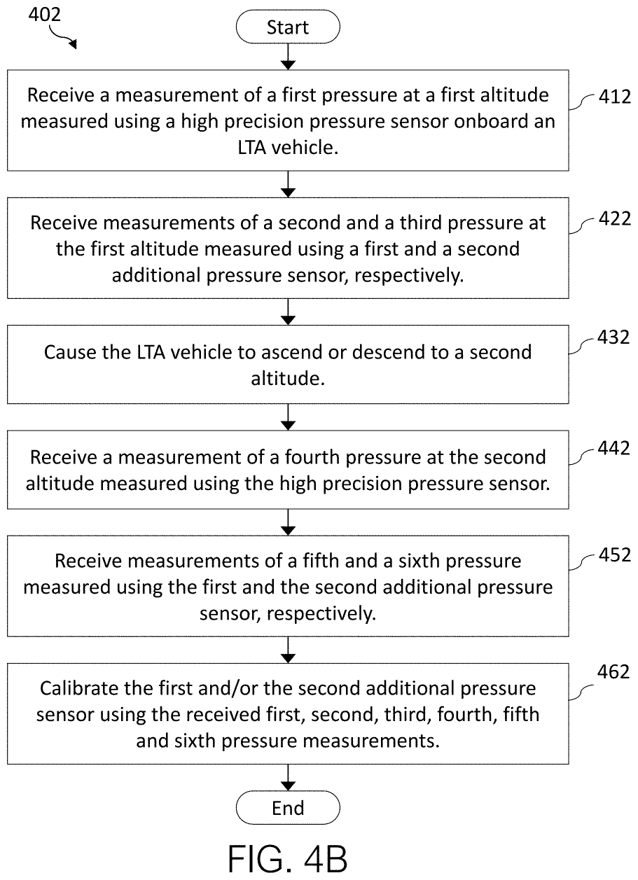

FIG. 4A is a flow diagram illustrating a method 400 for calibrating a pressure sensor onboard an LTA vehicle using a high precision pressure sensor onboard the LTA vehicle. PSC systems, such as 100 in FIG. 1 or 200 in FIG. 2, can be used to perform method 400. In step 410, a first pressure measurement is received by a processor (e.g., processor 130 in FIG. 1, or 230 in FIG. 2). The first pressure measurement is measured at a first altitude using a high precision pressure sensor that is onboard an LTA vehicle. The processor can be located onboard the LTA vehicle or can be located offboard the LTA vehicle, in different examples of method 400. In step 420, a second pressure measurement is received by the processor. The second pressure measurement is measured at the first altitude using a first additional pressure sensor that is onboard an LTA vehicle. In step 430, a flight computer (e.g., the processor, or a different computer in communication with the processor) causes an altitude of the LTA vehicle to change to a second altitude, which is either above or below the first altitude. In step 440, a third pressure measurement is received by the processor, where the third pressure measurement is measured using the high precision pressure sensor at the second altitude. In step 450, a fourth pressure measurement is received by the processor, where the fourth pressure measurement is measured using the first additional pressure sensor at the second altitude.

In step 460, the processor calibrates the first additional pressure sensor using the first, second, third, and fourth pressure measurements using a calibration procedure described herein.

The PSC system (e.g., 100 in FIG. 1, or 200 in FIG. 2) can perform the method 400 using the processor to receive measurements from the plurality of onboard pressure sensors (e.g., in steps 410, 420, 440 and 450) and then calibrate one or more of the pressure sensors based on the measurements from the other pressure sensors (e.g., in step 460). For example, measurements from one pressure sensor (e.g., the accurate high precision pressure sensor) can be used to calibrate the other pressure sensors. In another example, measurements from more than one pressure sensor (e.g., wherein at least one of the more than one pressure sensors are accurate, for example, having been calibrated previously) can be used to calibrate the pressure sensors in the system (e.g., using voting or averaging). In some cases, memory (e.g., non-transitory computer readable memory) is coupled to the processor, and the measurements from the high precision and the additional pressure sensors are stored in the memory. The measurements stored in the memory are accessible by the processor, which can use the measurements to calibrate one or more of the pressure sensors in the PSC system. The PSC systems described herein can use any algorithm to calibrate one or more of the pressure sensors in the PSC system based on measurements from the pressure sensors in the PSC system.

For example, the PSC system can perform the method 400 by the processor (e.g., processor 130 in FIG. 1, or 230 in FIG. 2) receiving several sets of measurements from an accurate (e.g., previously calibrated) high precision pressure sensor and two (or more) additional pressure sensors at different altitudes during a flight of an LTA vehicle. Since the ambient air pressure changes with altitude, this procedure will generate sets of measurements (e.g., from 5 to 20, from 10 to 100, greater than 5, greater than 10, greater than 100 measurements, or within other ranges) at different pressures. The measurements can be compared with one another, and one (or more) of the additional pressure sensors can be calibrated to match the measurements of the accurate high precision pressure sensor for each set of measurements (e.g., for each altitude where measurements were taken). For example, differences between the measurements from each of the additional pressure sensors and the accurate high precision pressure sensor can be stored (e.g., in memory coupled to the processor) for each set of measurements taken at different altitudes, and then offsets can be applied, based on the differences, to calibrate each of the additional pressure sensors. In some cases, the additional pressure sensors output a raw (uncalibrated) measurement, and the processor applies a calibration offset based on the stored values generated in the above procedure.

In some cases, the calibration procedure in step 460 can include interpolation between data points (e.g., between the measurements taken at each altitude). For example, a function (e.g., a linear function, an nth degree polynomial, a logarithmic function, a power function, or an exponential function) can be fit to the calibrated points (e.g., to the calibrated pressure measurements, or the calibration offsets) to improve the pressure sensing accuracy for pressures in between the sets of pressure measurements used at the different altitudes during the above calibration procedure. In some cases, a lookup table of calibration offsets for any pressures between the measured points can be generated (and stored in memory accessible by a processor) using the measured pressures and interpolating between the measured points. In some cases, the fitted function or lookup table can include pressures beyond the range of the measured points by extrapolating from the measured data.

In some cases, the PSC systems (e.g., 100 in FIG. 1, or 200 in FIG. 2) can perform the method 400 by the processor (e.g., processor 130 in FIG. 1, or 230 in FIG. 2) receiving several sets of measurements from an accurate (e.g., previously calibrated) high precision pressure sensor and two (or more) additional pressure sensors at different altitudes during a flight of an LTA vehicle, and the measurements from all of the pressure sensors can be used to calibrate one or more of the pressure sensors of the PSC system. For example, all of the measurements from the pressure sensors at a particular altitude can be averaged to determine an average pressure, and the processor can determine the calibration offsets to apply to measurements from one or more of the pressure sensors (e.g., to all of the pressure sensors, or to all of the pressure sensors except the high precision pressure sensor) to match the determined average pressure. The processor can then store the calibration offsets (e.g., in memory coupled to the processor) and apply those offsets to the raw measurements of the pressure sensors in subsequent measurements.

In some cases, the PSC systems (e.g., 100 in FIG. 1, or 200 in FIG. 2) can perform the method 400 by the processor (e.g., processor 130 in FIG. 1, or 230 in FIG. 2) receiving several sets of measurements from an accurate (e.g., previously calibrated) high precision pressure sensor and two (or more) additional pressure sensors at different altitudes during a flight of an LTA vehicle, and the measurements from two or more of the pressure sensors can be used to calibrate one or more of the pressure sensors of the PSC system. For example, all of the measurements from the pressure sensors at a particular altitude can be compared, using the processor, to determine if any of the pressure sensors is measuring a pressure significantly different from the other pressure sensors. For example, all of the pressure measurements at a particular altitude can be analyzed statistically (e.g., to determine a mean, standard deviation, coefficient of variation, and/or other statistical parameters of the distribution of measurements), and then each pressure sensor can be designated as within a particular error bound, or outside of a particular error bound. The processor can then determine calibration offsets to apply to measurements from one or more of the pressure sensors (e.g., to all of the pressure sensors, to all of the pressure sensors except the high precision pressure sensor) outside of a particular bound, based on the measurements (or a statistical distribution of measurements) from one or more of the pressure sensors within a particular error bound. The processor can then store the calibration offsets (e.g., in memory coupled to the processor) and apply those offsets to the raw measurements of the pressure sensors in subsequent measurements.

In an example, a PSC system (e.g., 100 in FIG. 1, or 200 in FIG. 2) performs the method 400 and contains one accurate (e.g., previously calibrated) high precision pressure sensor and five additional pressure sensors, all of which are onboard an LTA vehicle. The measurements from the six pressure sensors at 10 different altitudes are received by the processor as the LTA vehicle ascends (and/or descends). The measurements at each altitude are then analyzed statistically by the processor to determine the mean pressure and the coefficient of variation of the pressures measured. An error bound in this example is predetermined to be two coefficients of variation away from the mean. If any of the additional pressure sensors in this example produces measurements that are more than two coefficients of variation away from the mean, then it is designated as outside the error bound, and that pressure sensor can be calibrated using calibration procedures described herein (e.g., as determined by the high precision pressure sensor, or from the mean of all of the pressure sensors that are inside the error bound, or from all of the pressure sensors that output raw pressure measurements that are less than two coefficients of variation away from the mean).

In some cases, the PSC system (e.g., 100 in FIG. 1, or 200 in FIG. 2) performs the method 400 by the processor (e.g., processor 130 in FIG. 1, or 230 in FIG. 2) receiving several sets of measurements from an accurate (e.g., previously calibrated) high precision pressure sensor and two (or more) additional pressure sensors at different altitudes during a flight of an LTA vehicle, and the processor votes to determine which measurements from which of the pressure sensors are used to calibrate one or more of the pressure sensors of the PSC system. The processor can vote to determine which measurements from which of the pressure sensors are used based on statistical distributions of the measurements, comparisons between the measurements from different pressure sensors, or any other criteria. For example, if a PSC system contains three pressure sensors, and two of the pressure sensors are outputting similar measurements (e.g., within a certain absolute percentage difference, such as within 1% or 5% difference), while one of the pressure sensors is outputting a different measurement (e.g., greater than a certain absolute percentage difference, such as greater than a 1% or 5% difference), then the one pressure sensor outputting the different pressure measurement can be calibrated based on the measurement of one or both of the other pressure sensors (e.g., using procedures described herein). In some cases, the processor can vote to determine which measurements from which of the additional pressure sensors are used based on measurements from the high precision pressure sensor.

In some cases, the PSC system calibration procedure, performed by the processor in step 460, uses voting and measurements from a plurality of additional pressure sensors are compared to measurements from an accurate (e.g., previously calibrated) high precision pressure sensor (e.g., at different altitudes) to determine which measurements to use for calibration. For example, any additional pressure sensors that output similar measurements to the accurate high precision pressure sensor (e.g., within a certain absolute percentage difference, such as within 1% or 5% difference) can be used to calibrate any additional pressure sensors outputting a measurements that are different from those of the accurate high precision pressure sensor (e.g., greater than a certain absolute percentage difference, such as greater than a 1% or 5% difference). In such cases, the pressure sensors outputting the different pressure measurement can be calibrated based on the measurements of the high precision pressure sensors and/or the other pressure sensors (e.g., using procedures described herein).

FIG. 4B is a flow diagram illustrating a method 402 for calibrating two pressure sensors onboard an LTA vehicle using a high precision pressure sensor onboard the LTA vehicle. In some cases, PSC systems having a high precision pressure sensor and two additional pressure sensors is advantageous. For example, in long duration flights, pressure sensor drift can be detected by comparing the measurements of three pressure sensors to determine if one of the pressure sensors has drifted significantly more than the other two pressure sensors. PSC systems, such as 100 in FIG. 1 or 200 in FIG. 2, can be used to perform method 402. In step 412 of FIG. 4B, a first pressure measurement is received by a processor (e.g., processor 130 in FIG. 1, or 230 in FIG. 2). The first pressure measurement is measured at a first altitude using a high precision pressure sensor that is onboard an LTA vehicle. The processor can be located onboard the LTA vehicle or can be located offboard the LTA vehicle, in different examples of method 402. In step 422, a second and a third pressure measurement is received by the processor. The second and third pressure measurements are measured at the first altitude using a first and a second additional pressure sensor, respectively. The first and second additional pressure sensors are also located onboard the LTA vehicle, in this case. In step 432, a flight computer (e.g., the processor, or a different computer in communication with the processor) causes an altitude of the LTA vehicle to change to a second altitude, which is either above or below the first altitude. In step 442, a fourth pressure measurement is received by the processor, where the fourth pressure measurement is measured using the high precision pressure sensor at the second altitude. In step 452, a fifth and a sixth pressure measurement is received by the processor, where the fifth and the sixth pressure measurements are measured using the first and second additional pressure sensors, respectively, at the second altitude. In step 462, the processor calibrates the first and/or the second additional pressure sensors using the first, second, third, fourth, fifth and sixth pressure measurements using a calibration procedure described herein (e.g., the calibration procedures described with respect to method 400).

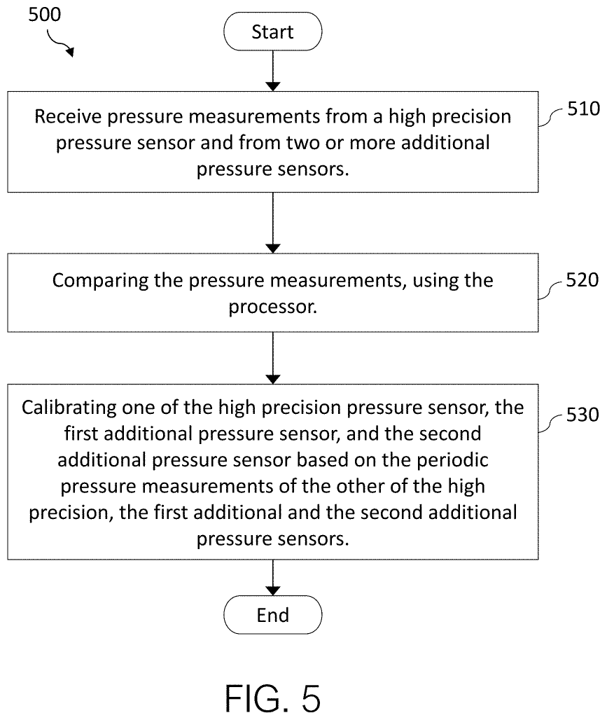

FIG. 5 is a flow diagram illustrating a method 500 for calibrating pressure sensors onboard an LTA vehicle using a high precision pressure sensor onboard the LTA vehicle. PSC systems, such as 100 in FIG. 1 or 200 in FIG. 2, can be used to perform method 500. In step 510, pressure measurements are received by a processor (e.g., processor 130 in FIG. 1, or 230 in FIG. 2). The pressure measurements are measured using a high precision pressure sensor and two or more additional pressure sensors. The processor can be located onboard the LTA vehicle or can be located offboard the LTA vehicle, in different examples of method 500. In step 520, a processor compares the pressure measurements from the high precision pressure sensor and from the two or more additional pressure sensors. In step 530, one or more of the high precision pressure sensor, the first additional pressure sensor, and the second additional pressure sensor are calibrated based on the pressure measurements of the other two pressure sensors using a calibration procedure described herein (e.g., the calibration procedures described with respect to method 400).

Optionally, after performing step 540, the steps 510 through 540 can be repeated to recalibrate one or more of the high precision pressure sensor, the first additional pressure sensor, and/or the second additional pressure sensor. For example, the sensors can be recalibrated at regular or irregular intervals of time. In some cases, one or more of the sensors can be recalibrated when the measured absolute pressure and/or pressure altitude changes significantly (e.g., by more than 1%, or by more than 5%) compared to a previous calibration of the one or more sensors.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. A lighter than air (LTA) vehicle, comprising:
a redundant pressure sensor calibration system, comprising:
a high precision pressure sensor onboard an LTA vehicle;
two or more additional pressure sensors onboard the LTA vehicle, wherein the two or more additional pressure sensors are each redundant with the high precision pressure sensor; and
a processor that is configured to calibrate the two or more additional pressure sensors based on pressure measurements from the high precision pressure sensor and the two or more additional pressure sensors at two or more altitudes,
wherein the high precision pressure sensor is calibrated before a flight of the LTA vehicle.

2. The lighter than air (LTA) vehicle of claim 1, wherein the processor is located onboard the LTA vehicle.

3. The lighter than air vehicle of claim 1, wherein the processor is located offboard the lighter than air vehicle, and the pressure measurements from the high precision pressure sensor and the two or more additional pressure sensors are transmitted from a first communications unit onboard the lighter than air vehicle to a second communications unit coupled to the processor using telemetry.

4. The lighter than air vehicle of claim 1, wherein one of the high precision and the two or more additional pressure sensors is in an enclosure and another of the high precision and the two or more additional pressure sensors is not enclosed.

5. The lighter than air vehicle of claim 1, wherein the high precision pressure sensor is a micro-electromechanical system (MEMS) based sensor coupled to an analog-to-digital converter.

6. The lighter than air vehicle of claim 1, wherein the high precision pressure sensor is calibrated before the flight of the LTA vehicle according to an industry or regulatory standard.

7. The lighter than air vehicle of claim 1, wherein the high precision pressure sensor is calibrated before the flight of the LTA vehicle at a pressure of 29.921 inches of mercury to measure an altitude of 0 feet with a tolerance of +/−20 feet.

8. The lighter than air vehicle of claim 1, further comprising:
a flight termination subsystem coupled to the PSC system, wherein a second set of pressure measurements from one or more of the high precision pressure sensor and the two or more additional pressure sensors are used to actuate one or more components of the flight termination subsystem.

9. The lighter than air vehicle of claim 8, wherein the one or more components of the flight termination subsystem actuated by the processor comprise one or more squibs.

10. The lighter than air (LTA) vehicle of claim 8, wherein the flight termination subsystem is configured to actuate the one or more components based on the LTA vehicle descending below an altitude threshold.

11. A method of calibrating redundant pressure sensors for a lighter than air (LTA) vehicle, comprising:
receiving, by a processor, a first pressure measurement measured at a first altitude using a high precision pressure sensor that is onboard an LTA vehicle;
receiving, by the processor, a second and a third pressure measurement measured at the first altitude using a first and a second additional pressure sensor, respectively, wherein the first and the second additional pressure sensors are onboard the LTA vehicle, and the first and second additional pressure sensors are each redundant with the high precision pressure sensor;
causing an altitude of the LTA vehicle to change to a second altitude;
receiving, by a processor, a fourth pressure measurement measured at the second altitude using the high precision pressure sensor;
receiving, by a processor, a fifth and a sixth pressure measurement measured at the second altitude using the first and the second additional pressure sensor, respectively; and
calibrating, by the processor, the first and second additional pressure sensors using the first, second, third, fourth, fifth and sixth pressure measurements.

12. The method of claim 11, wherein the causing the altitude of the lighter than air (LTA) vehicle to change comprises the LTA vehicle ascending during an initial ascent.

13. The method of claim 11, wherein the processor is onboard the lighter than air vehicle, and the receiving, by the processor, the first, second, third, fourth, fifth and sixth pressure measurements comprises the processor receiving local signals from the high precision pressure sensor, the first additional pressure sensor, and the second additional pressure sensor.

14. The method of claim 11, wherein the processor is located offboard the lighter than air (LTA) vehicle, and the receiving, by the processor, the first, second, third, fourth, fifth and sixth pressure measurements further comprises transmitting signals from a first communications unit onboard the LTA vehicle to a second communications unit coupled to the processor using telemetry.

15. The method of claim 11, wherein calibrating, by the processor, the first and second additional pressure sensors using the first, second, third, fourth, fifth and sixth pressure measurements further comprises applying offsets to the second, third, fifth and sixth pressure measurements such that after applying the offsets the second and third pressure measurements from the first additional pressure sensor match the first pressure measurement from the high precision pressure sensor and the fifth and the sixth pressure measurements from the second additional pressure sensor match the fourth pressure measurement from the high precision pressure sensor.

16. The method of claim 11, wherein calibrating, by the processor, the first and second additional pressure sensors using the first, second, third, fourth, fifth and sixth pressure measurements comprises interpolating between the pressure measurements measured at the first and second altitudes.

17. The method of claim 11, wherein calibrating, by the processor, the first and second additional pressure sensors using the first, second, third, fourth, fifth and sixth pressure measurements further comprises performing statistical analyses of the first, second, third, fourth, fifth and sixth pressure measurements and applying offsets to the measurements from the high precision pressure sensor, the first additional pressure sensor, or the second additional pressure sensor based on the statistical analyses.

18. The method of claim 17, wherein the statistical analyses comprise:
calculating a mean, a standard deviation, or a coefficient of variation of the first, second and third pressure measurements; and
calculating a mean, a standard deviation, or a coefficient of variation of the fourth, fifth and sixth pressure measurements.

19. The method of claim 11, wherein calibrating, by the processor, the first and second additional pressure sensors using the first, second, third, fourth, fifth and sixth pressure measurements further comprises the processor voting to determine which measurements from which pressure sensors are used to calibrate the high precision pressure sensor, the first additional pressure sensor, or the second additional pressure sensor.

20. The method of claim 11, further comprising:
after calibrating the first and second additional pressure sensors, receiving pressure measurements from the high precision pressure sensor, and the first and the second additional pressure sensors;
comparing the pressure measurements, using the processor, from the high precision pressure sensor, the first additional pressure sensor, and the second additional pressure sensor;
calibrating one of the high precision pressure sensor, the first additional pressure sensor, or the second additional pressure sensor based on the pressure measurements of the other two pressure sensors.
